(19) United States
(12) Patent Application Publication
(10) Pub. No.: US 2026/0176448 A1
(43) Pub. Date: Jun. 25, 2026

(54) FLUORINE-FREE (PFA-FREE) ADDITIVES FOR SURFACE MODIFICATION OF PLASTICS AND FIBERS USING GEMINI-BIS-ALKYL TEREPHTHALAMIDE MATERIALS

(71) Applicants: Arizona Board of Regents on behalf of Arizona State University, SCOTTSDALE, AZ (US); Alliance for Energy Innovation, LLC, Golden, CO (US)

(72) Inventors: Husain Mithaiwala, Tempe, AZ (US); Matthew Green, Phoenix, AZ (US); Robert David Allen, Golden, CO (US)

(21) Appl. No.: 19/427,533

(22) Filed: Dec. 19, 2025

Related U.S. Application Data
(60) Provisional application No. 63/736,754, filed on Dec. 20, 2024.

(51) Int. Cl. C08K 5/17; C08G 63/183

(52) U.S. Cl. CPC C08K 5/17; C08G 63/183

(57) ABSTRACT

Synthesizing a bis-alkyl terephthalamide includes combining a polymeric material including a polyethylene terephthalate with an alkylamine and a reaction mediator to yield a mixture, heating the mixture to yield a heterogeneous mass, and isolating the bis-alkyl terephthalamide from the heterogenous mass. The reaction mediator includes ethylene glycol. Modifying a polymeric material includes combining the polymeric material with a bis-alkyl terephthalamide to yield a mixture, heating the mixture, and extruding the mixture to yield a modified polymeric material. A modified polymeric material includes a polymeric material and a surface modifier including bis-alkyl terephthalamide, wherein the modified polymeric material includes 0.1 wt% to 10 wt% of the bis-alkyl terephthalamide.

### CROSS-REFERENCE TO RELATED APPLICATION

This application claims the benefit of U.S. Patent Application No. 63/736,754 filed on December 20, 2024, which is incorporated by reference herein in its entirety.

### STATEMENT OF GOVERNMENT SUPPORT

### This invention was made with government support under Contract No. DE-AC36-08GO28308 awarded by the Department of Energy. The government has certain rights in the invention.

### TECHNICAL FIELD

This invention relates to an application of bis-alkyl terephthalamide compounds as surface modifiers for commodity plastics derived from the deconstruction of polyethylene terephthalate or polyethylene terephthalate glycol copolymers via a glycol-mediated aminolysis reaction.

### BACKGROUND

Plastic waste is typically a mixture composed of various polymers (e.g., polyethylene terephthalate, polyethylene, polyvinyl chloride, polypropylene, and polystyrene). Per- and polyfluoroalkyl substances (PFAS) are commonly found in environmental media at least in part because of their use in a variety of industrial processes and consumer products. PFAS encompass a diverse group of >4700 chemicals defined as substances containing at least one fully fluorinated methyl or methylene carbon atom. When fluorinated alkyl chains are connected in series, they exhibit a blend of hydrophobic and lipophobic properties. However, PFAS are of concern due at least in part to their high persistence (or degradation products) and their impacts on human and environmental health.

### SUMMARY

This disclosure describes use of bis-alkyl terephthalamide compounds as surface modifiers for different commodity plastics generated from the deconstruction of polyethylene terephthalate or polyethylene terephthalate glycol copolymers via glycol-mediated aminolysis. The surface of polymers can be rendered substantially more hydrophobic by incorporating bis-alkyl terephthalamide compounds through an extrusion process. The bis-alkyl terephthalamide compounds are amphiphiles, recognized as Gemini surfactants with twin tails and head groups. Gemini surfactants refer to a class of surfactants that include two hydrophobic tails and two hydrophilic head groups connected by a spacer, forming a single molecule. In bis-alkyl terephthalamide compounds, the head groups (associated amides with benzene ring) serve as the polar hydrophilic H-bonders and the long chain alkyl groups serve as the hydrophobic tail end, as shown in FIG. 1A. When combined with plastics, the Gemini-bis-alkyl terephthalamide compounds populate the surface of plastics and impart hydrophobic properties. The upcycled bis-alkyl terephthalamide compounds obtained from polyethylene terephthalate precursors can replace per- and polyfluoroalkyl substances (PFAS) and silicones in plastic additive applications such as coatings, surface modifiers, and fabrics. Gemini-bis-alkyl terephthalamide compounds can be used for making different plastic melts compatible during the extrusion process. Furthermore, polyethylene terephthalate waste can be upcycled into plastic additives.

In a first general aspect, synthesizing a bis-alkyl terephthalamide includes combining a polymeric material including a polyethylene terephthalate with an alkylamine and a reaction mediator to yield a mixture, wherein the reaction mediator includes ethylene glycol, heating the mixture to yield a heterogeneous mass, and isolating the bis-alkyl terephthalamide from the heterogenous mass.

Implementations of the first general aspect can include one or more of the following features.

The polymeric material can include virgin polymeric material, waste polymeric material, or a combination thereof. In some cases, the polymeric material includes bottles, resins, textiles, films, storage containers, or a combination thereof. The polymeric material can include a polyethylene terephthalate glycol resin. In some cases, the polymeric material includes a polyester textile. The alkylamine can include a C4-C18 alkylamine. In some implementations, heating the mixture includes heating at a temperature in a range of 100 °C to a boiling point of the alkylamine. Isolating the bis-alkyl terephthalamide from the heterogenous mass can include washing the heterogenous mass with a solvent to yield a washed heterogeneous mass. In some cases, the washing includes removing unreacted amines and the reaction mediator from the heterogeneous mass with the solvent. The bis-alkyl terephthalamide can include N¹, N⁴-dioctylterephthalamide, N¹, N⁴-didodecylterephthalamide, N¹, N⁴-dihexadecylterephthalamide, or a combination thereof.

In a second general aspect, modifying a polymeric material includes combining the polymeric material with a bis-alkyl terephthalamide to yield a mixture, heating the mixture, and extruding the mixture to yield a modified polymeric material.

Implementations of the second general aspect can include one or more of the following features.

The polymeric material can include a polyethylene terephthalate, a high-density polyethylene, a low-density polyethylene, a polyvinyl chloride, or any combination thereof. In some cases, the polyethylene terephthalate includes a polyethylene terephthalate glycol resin, a polyvinyl chloride resin, or a combination thereof. In some cases, the modified polymeric material includes 0.1 wt% to 10 wt% of the bis-alkyl terephthalamide with respect to the extruded polymer. The bis-alkyl terephthalamide can include N¹, N⁴-dioctylterephthalamide, N¹, N⁴-didodecylterephthalamide, N¹, N⁴-dihexadecylterephthalamide, or a combination thereof.

In a third general aspect, a modified polymeric material includes a polymeric material and a surface modifier including bis-alkyl terephthalamide, wherein the modified polymeric material includes 0.1 wt% to 10 wt% of the bis-alkyl terephthalamide.

Implementations of the third general aspect can include one or more of the following features.

The material can include polyethylene terephthalate, a high-density polyethylene, a low-density polyethylene, a polyvinyl chloride, or a combination thereof. In some cases, the polymeric material includes a polyethylene terephthalate glycol resin, a polyvinyl chloride resin, or a combination thereof. The modified polymeric material can be in the form of an extruded film or a filament. In some implementations, the bis-alkyl terephthalamide lowers the surface energy of the polymeric material.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A shows a generalized structure of Gemini-bis-alkyl terephthalamide compounds. FIG. 1B is a flow chart showing operations in a process to synthesize a bis-alkyl terephthalamide. FIG. 1C is a flow chart showing operations in a process to modify a polymeric material.

FIG. 2 shows a reaction schematic of ethylene glycol-mediated aminolysis of polyethylene terephthalate using various alkylamines.

FIG. 3 shows water contact angle measurements of extruded polyethylene terephthalate glycol films with different loading conditions of bis-alkyl terephthalamide compounds. Values reported are mean values with one standard deviation.

FIG. 4 shows water contact angle measurements of extruded neat polyvinyl chloride and N¹, N⁴-dihexadecylterephthalamide loaded films. Reported are mean values with one standard deviation.

### DETAILED DESCRIPTION

This disclosure describes using bis-alkyl terephthalamide compounds as surface modifiers for commodity plastics, allowing their upcycling for applications (e.g., plastic additive applications).

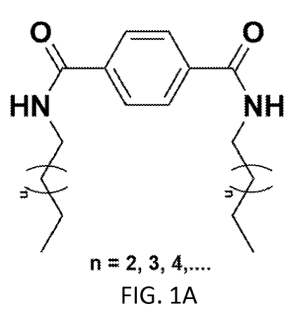

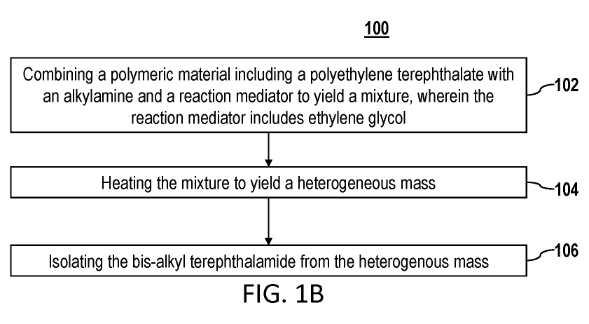

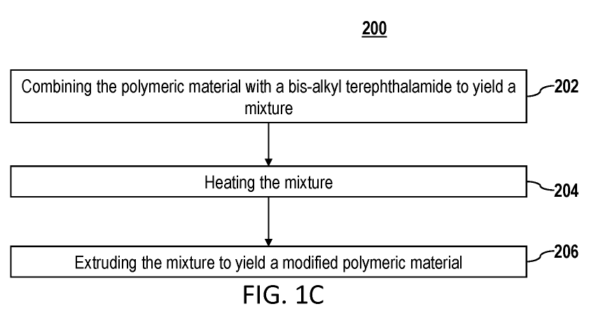

FIG. 1B is a flow chart showing operations in process 100 to synthesize a bis-alkyl terephthalamide. In 102, a polymeric material including a polyethylene terephthalate is combined with an alkylamine and a reaction mediator (e.g., ethylene glycol) to yield a mixture. In 104, the mixture is heated to yield a heterogeneous mass. In 106, the bis-alkyl terephthalamide is isolated from the heterogenous mass. Heating the mixture includes heating at a temperature in a range of 100 °C to a boiling point of the alkylamine (e.g., 125 °C).

The polymeric material can be virgin polymeric material, waste polymeric material, or a combination of. Virgin polymeric material generally refers to polymeric material that has not been previously used. Waste polymeric material generally refers to polymeric material that has been previously used and discarded, such as post-consumer or post-industrial polymeric material. The polymeric material can include bottles, resins, textiles, films, storage containers, or a combination thereof. Examples of suitable polymeric materials include polyethylene terephthalates (e.g., polyethylene terephthalate, modified polyethylene terephthalates such as polyethylene terephthalate glycol), high-density polyethylene, low-density polyethylene, polyvinyl chloride, or any combination thereof. In one example, the polymeric material includes a polyethylene terephthalate glycol resin. In one example, the polymeric material includes a polyester textile. In one example, the polymeric material includes waste polyethylene terephthalate plastic bottles.

Suitable alkylamines include C4-C18 alkylamines. In some cases, the alkylamine includes butylamine (C4), amylamine (C5), hexylamine (C6), heptylamine(C7), N-octylamine (C8), nonylamine (C9), decylamine (C10), dodecylamine (C12), tetradecylamine (C14), hexadecylamine (C16), octadecylamine (C18), isobutylamine, isopentylamine, (2-methylbutyl)amine, 2-ethyl-1-hexylamine, or any combination thereof. In one example, the alkylamine is N-octylamine. In one example, the alkylamine is dodecylamine. In one example, the alkylamine is hexadecylamine.

The isolation of bis-alkyl terephthalamide from the heterogenous mass includes washing the heterogeneous mass with a solvent to yield a washed heterogeneous mass. Washing the heterogeneous mass promotes removal of unreacted amines and the reaction mediator from the heterogeneous mass with the solvent. A suitable example of the solvent is acetone. The synthesized bis-alkyl terephthalamide can include N¹, N⁴-dioctylterephthalamide, N¹, N⁴- didodecylterephthalamide, N¹, N⁴-dihexadecylterephthalamide, or a combination thereof.

FIG. 1C is a flow chart showing operations in process 200 to modify a polymeric material. In 202, the polymeric material is combined with a bis-alkyl terephthalamide to yield a mixture. In 204, the mixture is heated. In 206, the mixture is extruded to yield a modified polymeric material. In some examples, the modified polymeric material is in the form of a film or a filament.

The polymeric material to be modified can be virgin polymeric material, waste polymeric material, or a combination of. Examples of suitable polymeric materials to be modified include polyethylene terephthalates (e.g., polyethylene terephthalate, modified polyethylene terephthalates such as polyethylene terephthalate glycol), high-density polyethylene, low-density polyethylene, polyvinyl chloride, or any combination thereof. In one example, the polymeric material includes a polyethylene terephthalate glycol resin. In one example, the polymeric material includes a polyvinyl chloride resin.

The modified polymeric material typically includes 0.1 wt% to 10 wt% of the bis-alkyl terephthalamide with respect to the extruded polymer (e.g., 0.1 wt%, 0.5 wt%, 1 wt%, or 5 wt%). The bis-alkyl terephthalamide can include N¹, N⁴-dioctylterephthalamide, N¹, N⁴- didodecylterephthalamide, N¹, N⁴-dihexadecylterephthalamide, or a combination thereof. Extruding the mixture can occur at a temperature in a range of 170 °C to 230 °C (e.g., 170 °C, 180 °C, 185 °C, 190 °C, 200 °C, 210 °C, 215 °C, 220 °C, or 230 °C). The bis-alkyl terephthalamide lowers the surface energy of the polymeric material.

### EXAMPLES

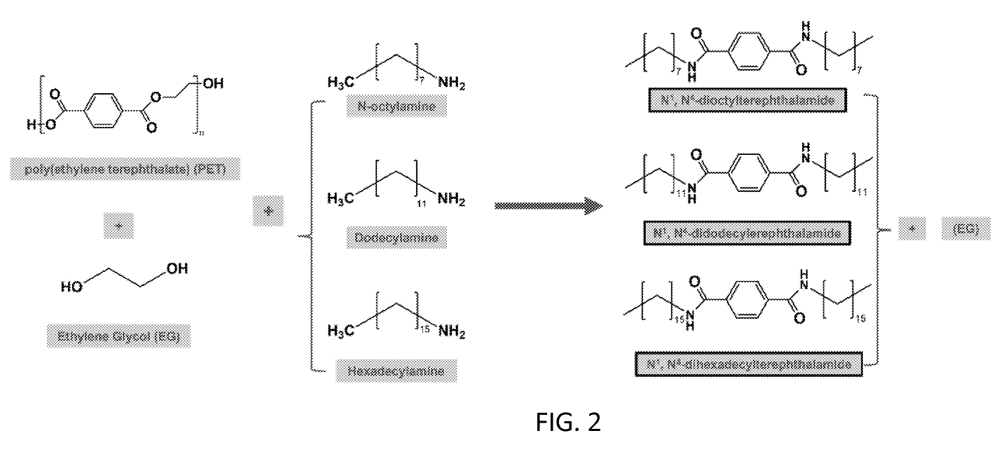

The bis-alkyl terephthalamide compounds were synthesized by glycol-mediated aminolysis of polyethylene terephthalate or polyethylene terephthalate glycol copolymers. Waste polyethylene terephthalate plastic bottles (1 mol) were chopped into pieces or commercial Polyethylene terephthalate glycol resins (1 mol) were loaded into a 50 mL round bottom flask equipped with a magnetic stir bar. N-octylamine (C8, 6 moles), dodecylamine (C12, 4.2 moles) and hexadecylamine (C16, 3.2 moles) were used as the long chain alkylamine for the aminolysis reaction. Ethylene glycol (12 moles) was added as the reaction mediator along with the amines. The round bottom flask was sealed and purged with nitrogen for 15 minutes along with constant stirring. The nitrogen was removed and the round bottom flask was lowered in an oil bath maintained at 125 °C. The reaction continued for 6 hours to achieve complete conversion. The heterogenous mass obtained after completion of the reaction was mixed with excess of acetone to remove unreacted amines and ethylene glycol. After mixing with acetone, the heterogeneous mass was filtered and isolated. The product of this reaction is referred to as bis-alkyl terephthalamide compounds. Three types of bis-alkyl terephthalamide compounds were synthesized from aminolysis using N-octylamine, dodecylamine, and hexadecylamine to obtain N¹, N⁴-dioctylterephthalamide, N¹, N⁴-didodecylterephthalamide, and N¹, N⁴-dihexadecylterephthalamide, respectively. A reaction scheme is shown in FIG. 2.

An Xplore Microcompounder MC 5 (twin-screw extruder) was utilized to extrude plastic films using a 0.5 mm thin-film die. The extruder operates at speeds ranging from 0 to 400 revolutions per minute (RPM) and can handle temperatures between 30 °C and 400 °C. While the maximum sample capacity is 5 mL, 4.0 mL to 4.5 mL was typically used. Commercial polyvinyl chloride and polyethylene terephthalate glycol resins were utilized to extrude thin films. Bis-alkyl terephthalamide compounds were used as surface modifiers along with these polymers in the extrusion.

Commercial polyethylene terephthalate glycol resins were initially dried at 60 °C in an oven for 4 hours prior to extrusion to reduce moisture. The extrusion temperature was between 200 °C and 230 °C. For control samples, 4 g of polyethylene terephthalate glycol resin were loaded in the sample hopper. During the loading process, the twin screw was operated at 50 RPM and the temperature was maintained at 215 °C. After loading was completed, the polyethylene terephthalate glycol resins were circulated inside the extruder for 2 minutes at 150 RPM and the films were extruded from the thin-film die. The bis-alkyl terephthalamide modified polyethylene terephthalate glycol films were extruded at different loading conditions of bis-alkyl terephthalamide compounds: 0.1 wt%, 0.5 wt%, 1.0 wt% and 5 wt% of bis-alkyl terephthalamide compounds with respect to polyethylene terephthalate glycol resins. N¹, N⁴-dioctylterephthalamide, N¹, N⁴-didodecylterephthalamide, and N¹, N⁴-dihexadecylterephthalamide products were utilized as the bis-alkyl terephthalamide compounds. Bis-alkyl terephthalamide compounds were thoroughly mixed with the polyethylene terephthalate glycol resin in the charging hopper. The motor speed and temperature were maintained at 50 RPM and 215 °C, respectively. After loading, the mixture was allowed to mix for 2 minutes at 150 RPM inside the extruder before extruding films. Duplicates were performed for each concentration of bis-alkyl terephthalamide compounds with polyethylene terephthalate glycol resin.

Polyvinyl chloride resins were obtained commercially for extrusion processes. The extrusion temperature was set between 170 °C and 200 °C. For control runs, polyvinyl chloride was loaded into the sample hopper and introduced into the barrel with motor speed adjusted to 50 RPM and temperature at 185 °C. The resin was allowed to mix and melt for 2 minutes at 150 RPM before extrusion through the thin-film die. For polyvinyl chloride, N¹, N⁴-dihexadecylterephthalamide was used as the bis-alkyl terephthalamide compound at 1 wt%, 5 wt%, and 10 wt% loading concentrations with respect to polyvinyl chloride resin. N¹, N⁴-dihexadecylterephthalamide was mixed with polyvinyl chloride in the sample hopper at 50 RPM and 185 °C and introduced into the barrel. Then, the melt was mixed for 2 minutes at 150 RPM before extrusion. Duplicates were performed for all N¹, N⁴-dihexadecylterephthalamide loadings with polyvinyl chloride resin.

Contact angle measurements were performed on a Rame-Hart goniometer/tensiometer Model 290 with DROPimage Advanced software. A Hamilton 1750TPLT 0.5 mL, PLNGR TYPE syringe along with a 16-gauge stainless steel blunt needle was used to dispense a 5 µL droplet of Milli-Q® water. Extruded films were fixed to a glass slide using double-sided Scotch^{TM} tape. For each film, 10 measurements every 3 seconds were taken at 5 different locations, immediately after dispensing the droplet.

A TA Instruments Q2000 calorimeter was used to determine the glass-transition temperatures (T_{g}) of the extruded polyethylene terephthalate glycol films. The films were heated under a nitrogen atmosphere at a rate of 10 °C/min to 250 °C, held isothermally for 10 minutes, cooled to 25 °C, held isothermally for 10 minutes, and finally heated again at a rate of 10 °C/min to 250 °C. The polymer samples were loaded into a non-hermetically sealed aluminum pan, and the T_{g} values of the polymers were determined from the midpoint T_{g} function in the TA instruments Universal Analysis 2000 software (version 4.5A).

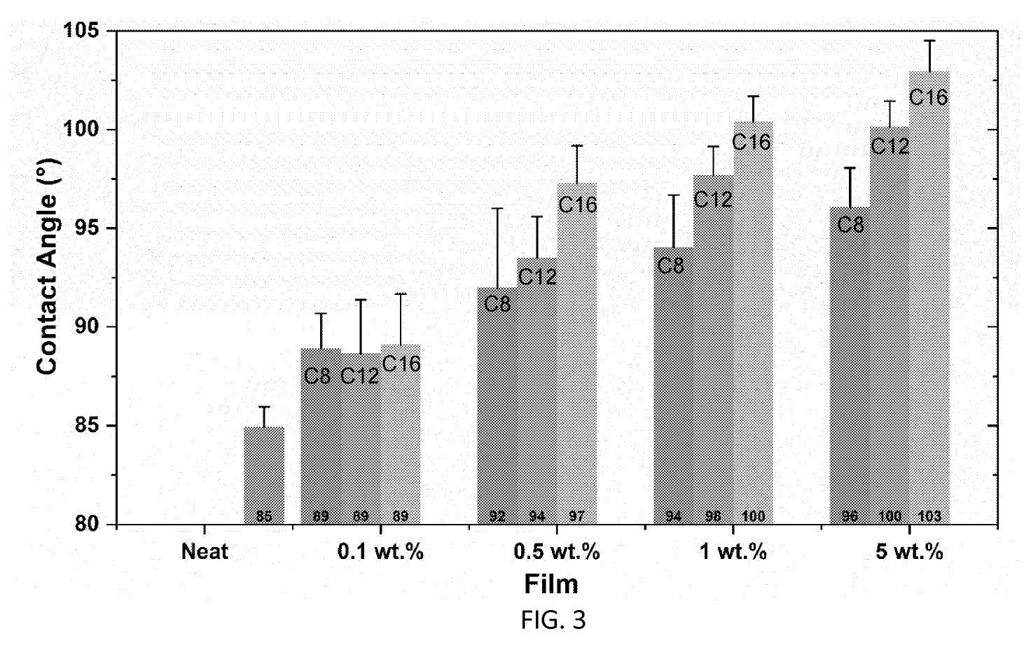

Recorded water contact angle values for neat and bis-alkyl terephthalamide loaded polyethylene terephthalate glycol films are shown in FIG. 3. The neat polyethylene terephthalate glycol film (film extruded with no additive) establishes a water contact angle of 85°. With the introduction of bis-alkyl terephthalamide compounds at 0.1 wt%, the water contact angle shows an increase to an average of 89° for N¹, N⁴-dioctylterephthalamide, N¹, N⁴-didodecylterephthalamide, and N¹, N⁴-dihexadecylterephthalamide compounds. At 0.5 wt% loading, the N¹, N⁴-dioctylterephthalamide loaded film exhibits an average water contact angle of 92°, the N¹, N⁴-didodecylterephthalamide loaded film 94°, and the N¹, N⁴-dihexadecylterephthalamide loaded film 97°. Comparing the water contact angle values at 0.5 wt% demonstrates that bis-alkyl terephthalamide compounds the longer tail show a higher water contact angle. This suggested that the increase in hydrophobicity is due at least in part to the longer tail ends in the Gemini- bis-alkyl terephthalamide compounds (e.g., C12 and C16 compared to C8).

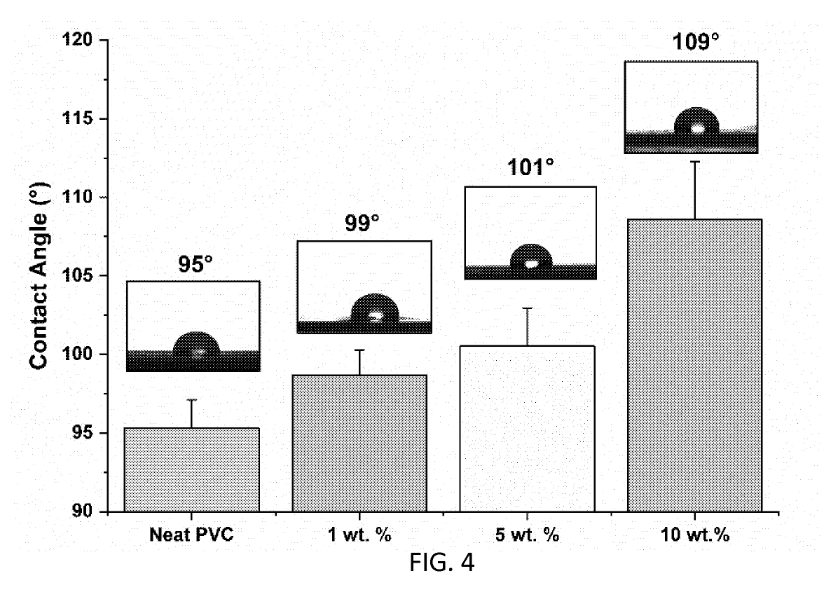

Similar observations were recorded at 1 wt % and 5 wt % extruded films. The water contact angle increased with the concentration of each loaded bis-alkyl terephthalamide compound. At same concentration, the longer tail additive exhibited a higher water contact angle. This behavior suggested that the bis-alkyl terephthalamide compounds can lower the surface energy of the polyethylene terephthalate glycol films, similar to the effect of per- and polyfluoroalkyl substances (PFAS) additives. The two hydrophilic amide head groups interact with the ester functionality on the polyethylene terephthalate glycol polymers via hydrogen bonding, while the long chain alkyl chain ends populate on the surface, imparting hydrophobicity. Differential scanning calorimetry analysis shows that the observed T_{g} of the films remains relatively constant at all measured bis-alkyl terephthalamide concentrations. This suggests that bis-alkyl terephthalamide compounds do not mix with the polyethylene terephthalate glycol polymer matrix. A similar water contact angle profile was observed for N¹, N⁴-dihexadecylterephthalamide loaded polyvinyl chloride films in FIG. 4, where the water contact angle increased with loading concentration (0 wt% to 10 wt %) from an average of 95° to 109°. The increased water contact angle in both polyethylene terephthalate glycol and polyvinyl chloride films confirm that bis-alkyl terephthalamide compounds are surface-active modifiers and can be sourced as a fluorine free additive.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of synthesizing a bis-alkyl terephthalamide, the method comprising:
combining a polymeric material comprising a polyethylene terephthalate with an alkylamine and a reaction mediator to yield a mixture, wherein the reaction mediator comprises ethylene glycol;
heating the mixture to yield a heterogeneous mass; and
isolating the bis-alkyl terephthalamide from the heterogenous mass.

2. The method of claim 1, wherein the polymeric material comprises virgin polymeric material, waste polymeric material, or a combination thereof.

3. The method of claim 2, wherein the polymeric material comprises bottles, resins, textiles, films, storage containers, or a combination thereof.

4. The method of claim 3, wherein the polymeric material comprises a polyethylene terephthalate glycol resin.

5. The method of claim 3, wherein the polymeric material comprises a polyester textile.

6. The method of claim 1, wherein the alkylamine comprises a C4-C18 alkylamine.

7. The method of claim 1, wherein heating the mixture comprises heating at a temperature in a range of 100 °C to a boiling point of the alkylamine.

8. The method of claim 1, wherein isolating the bis-alkyl terephthalamide from the heterogenous mass comprises washing the heterogenous mass with a solvent to yield a washed heterogeneous mass.

9. The method of claim 8, wherein the washing comprises removing unreacted amines and the reaction mediator from the heterogeneous mass with the solvent.

10. The method of claim 1, wherein the bis-alkyl terephthalamide comprises N¹, N⁴-dioctylterephthalamide, N¹,N⁴-didodecylterephthalamide, N¹,N⁴-dihexadecylterephthalamide, or a combination thereof.

11. A method of modifying a polymeric material, the method comprising:
combining the polymeric material with a bis-alkyl terephthalamide to yield a mixture;
heating the mixture; and
extruding the mixture to yield a modified polymeric material.

12. The method of claim 11, wherein the polymeric material comprises a polyethylene terephthalate, a high-density polyethylene, a low-density polyethylene, a polyvinyl chloride, or any combination thereof.

13. The method of claim 12, wherein the polyethylene terephthalate comprises a polyethylene terephthalate glycol resin, a polyvinyl chloride resin, or a combination thereof.

14. The method of claim 11, wherein the modified polymeric material comprises 0.1 wt% to 10 wt% of the bis-alkyl terephthalamide with respect to the extruded polymer.

15. The method of claim 11, wherein the bis-alkyl terephthalamide comprises N¹, N⁴-dioctylterephthalamide, N¹, N⁴-didodecylterephthalamide, N¹, N⁴-dihexadecylterephthalamide, or a combination thereof.

16. A modified polymeric material comprising:
a polymeric material; and
a surface modifier comprising bis-alkyl terephthalamide,
wherein the modified polymeric material comprises 0.1 wt% to 10 wt% of the bis-alkyl terephthalamide.

17. The modified polymeric material of claim 16, wherein the polymeric material comprises polyethylene terephthalate, a high-density polyethylene, a low-density polyethylene, a polyvinyl chloride, or a combination thereof.

18. The modified polymeric material of claim 16, wherein the polymeric material comprises a polyethylene terephthalate glycol resin, a polyvinyl chloride resin, or a combination thereof.

19. The modified polymeric material of claim 16, wherein the modified polymeric material is in the form of an extruded film or a filament.

20. The modified polymeric material of claim 16, wherein the bis-alkyl terephthalamide lowers the surface energy of the polymeric material.
